(19) United States
(12) Patent Application Publication
(10) Pub. No.: US 2019/0217683 A1
(43) Pub. Date: Jul. 18, 2019

(54) LIGHT EMISSION AND/OR AIR OUTLET OPENING FOR A PASSENGER COMPARTMENT OF A VEHICLE

(71) Applicant: fischer automotive systems GmbH & Co. KG, Horb a.N. (DE)

(72) Inventor: Falk SCHAAL, LoBburg (DE)

(21) Appl. No.: 16/221,466

(22) Filed: Dec. 15, 2018

(30) Foreign Application Priority Data
Jan. 16, 2018 (DE) 10 2018 100 851.1

(51) Int. Cl. B60H 1/26; B60H 1/00; B60H 1/32

(52) U.S. Cl. CPC B60H 1/26; B60H 1/32; B60H 1/00821

(57) ABSTRACT

An air vent for a passenger compartment of a motor vehicle, having a woven fabric disposed in the air outlet opening thereof, which increases the air permeability thereof upon expansion, whereby a volume of air can be controlled. If, alternatively, the woven fabric is illuminated from behind, a brightness can be varied by expanding the woven fabric.

### CROSS-REFERENCE TO RELATED APPLICATION

The present application claims priority under 35 USC § 119 to German Patent Application No. 10 2018 100 851.1, filed on Jan. 16, 2018, the entire disclosure of which is incorporated herein by reference.

### TECHNICAL FIELD

The invention relates to a light emission and/or an air outlet opening for a passenger compartment of a vehicle. The light emission opening is used to illuminate the passenger compartment, or a portion thereof, or for illuminating the light emission opening itself. The air outlet opening is provided to vent, heat and, if necessary, cool, the passenger compartment.

### RELATED ART

European patent application EP 1 151 879 A2 discloses an air vent for a passenger compartment of a vehicle having a large-surface-area air outlet opening, which is provided with a screen-like or filter-like cover causing air to flow out in a diffuse manner.

### SUMMARY

It is the object of the invention to propose a light emission and/or air outlet opening for a passenger compartment of a vehicle which allows air volume to be controlled.

The light emission and/or air outlet opening according to the invention for a passenger compartment of a vehicle includes a translucent and/or air-permeable closure, which can be expanded and/or compressed and, upon expansion or compression, changes the translucency and/or air permeability thereof. The closure can comprise an elastically expandable film, for example, which becomes thinner, and thereby more translucent, as a result of expansion. The film may be translucent or opaque when not expanded. The closure can comprise a firm, open-cell, air-permeable, elastic foam, comparable to a sponge, or a planar or three-dimensional textile, the air permeability thereof changing upon expansion or compression. If the foam or the textile is sufficiently thin and/or made of a translucent material, allowing light to pass through, this can also control light emission in a light emission opening. The closure can be a perforated, planar structure, having perforation openings that change the shape and surface area thereof when the structure is expanded or compressed. The list is by way of example and not exhaustive. The closure can be interpreted or designed as a kind of screen or filter having a variable mesh size, for example.

In particular, the closure is disposed in or on the light emission and/or air outlet opening so that no light and/or no air is able to pass by the closure and through the light emission and/or air outlet opening.

One embodiment of the invention provides for a device for expanding and/or compressing the closure, for example a linear actuator by way of which the closure can be expanded in one direction and/or compressed in another direction, preferably an opposite direction.

One embodiment of the invention provides that the closure comprises a blind including displaceable lamellae, the distance between which is variable by displacement of the lamellae. The lamellae are preferably disposed transversely or slightly obliquely with respect to light radiation and/or an air flow through the light emission and/or air outlet opening. An increase or a decrease in the distance between the lamellae shall be considered an expansion or compression of the closure within the meaning of the invention. In particular, the lamellae cannot be pivoted.

The features and feature combinations, designs and embodiments of the invention mentioned above in the description, and the features and feature combinations mentioned hereafter in the description of the figures and/or shown in a figure, can be used not only in the respective indicated or shown combinations, but also in other essentially arbitrary combinations, or alone. Embodiments of the invention that do not include all the features of a dependent claim are possible. It is also possible to replace individual features of a claim with other disclosed features or feature combinations. Embodiments of the invention that do not include all the features of the exemplary embodiment or exemplary embodiments, but an essentially arbitrary portion of the characterizing features of one exemplary embodiment, optionally in combination with one, more or all the features of one or more further exemplary embodiments are possible.

### BRIEF DESCRIPTION OF THE DRAWINGS

The invention will be described in more detail hereafter based on two exemplary embodiments shown in the drawings. In the drawings:

FIG. 1 shows a first exemplary embodiment of light emission and/or air outlet openings according to the invention.

FIG. 2 shows a second exemplary embodiment of light emission and/or air outlet openings according to the invention.

### DETAILED DESCRIPTION

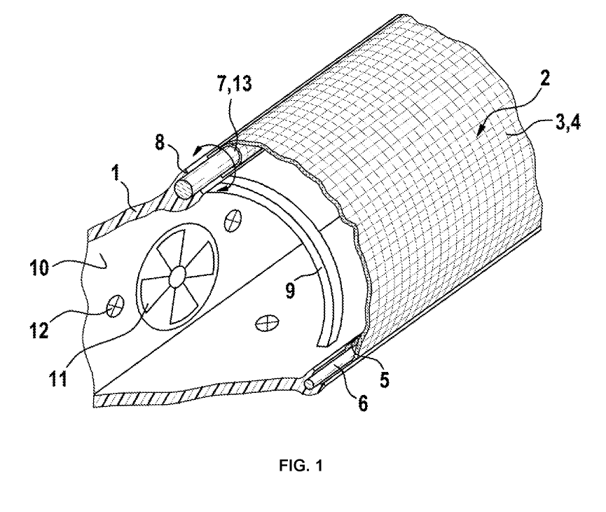

FIG. 1 shows a box-shaped housing 1 having a cross-section that is constant across a width of the housing 1 and expands in the direction of a light emission and/or air outlet opening 2 according to the invention of the housing 1. The light emission and/or air outlet opening 2 in the exemplary embodiment is rectangular and extends across the width of the housing 1, wherein the light emission and/or air outlet opening 2 can be narrower than the housing 1.

The light emission and/or air outlet opening 2 is covered by a woven fabric 3, which forms a translucent and air-permeable closure 4 of the light emission and/or air outlet opening 2. The woven fabric 3 can, generally speaking, also be considered to be a textile. The woven fabric 3 forming the closure 4 is disposed at, on, or in, the light emission and/or air outlet opening 2 so that no light and no air is able to pass by the woven fabric 3 and through the light emission and/or air outlet opening 2. The woven fabric 3 includes a loop 5 on an edge, in which a round rod is inserted serving as a welting 6, by way of which the loop 5 of the woven fabric 3 is accommodated in a groove, which forms a receptacle for the welting 6 and extends along an edge of the light emission and/or air outlet opening 2.

At an edge of the light emission and/or air outlet opening 2, located opposite the receptacle for the welting 6, the woven fabric 3 is wrapped around a shaft 7 and attached to the shaft 7, which is rotatably accommodated in a groove extending along the opposite edge of the light emission and/or air outlet opening 2. This groove forms a pivot mounting 8 for the shaft 7, which can be rotated by way of a mechanical gearbox using an electric motor, which is not visible in the drawing.

The woven fabric 3 is stretched over ribs 9, which are disposed at a distance next to one another in the light emission and/or air outlet opening 2 and extend between the two opposing edges of the light emission and/or air outlet opening 2 and which, in the exemplary embodiment, curve outwardly in an arc-shaped manner, seen from the housing 1. Other options for stretching the woven fabric 3 in or on the light emission and/or air outlet opening 2 in a desired shape include, for example, a screen-like or perforated wall, or ribs extending parallel to, or obliquely to, the opposite edges (not shown). The list is by way of example and not exhaustive. The ribs 9 may also be dispensed with.

By rotating the shaft 7, around which the woven fabric 3 forming the closure 4 of the light emission and/or air outlet opening 2 is wrapped and to which the woven fabric 3 is attached, the woven fabric 3 can be tightened or loosened to a higher degree. Tightening causes the woven fabric 3 to be expanded and increases the translucency and/or air permeability thereof. The woven fabric 3 causes a diffuse, which is to say non-directional, air flow out of the light emission and/or air outlet opening 2. By tightening, which is to say expanding, or loosening the woven fabric 3 forming the closure 4 of the light emission and/or air outlet opening 2, an air volume flowing through the woven fabric 3 and/or a passage of light can be controlled.

In a rear wall 10 located opposite the light emission and/or air outlet opening 2, the housing 1 includes one or more fans 11 for generating an air current and/or light sources 12, such as LEDs, for generating light. The fan or fans 11 and/or the light source or sources 12 can also be disposed in other locations of the housing 1, and the fan or fans 11 can also be disposed outside the housing 1. When the woven fabric 3 forming the closure 4 of the light emission and/or air outlet opening 2 is illuminated from behind, which is to say from inside the housing 1, it appears brighter or radiates more brightly due to the higher passage of light when the woven fabric 3 is expanded more strongly, and vice versa.

The housing 1 can comprise the fan 11 or another air source and/or one or more light sources 12. If only the passage of light, or only the passage of air, is desired, the closure 4 can be air-impermeable, or opaque.

The shaft 7, which can be rotated using the electric motor, which is not visible, by way of the gearbox, which likewise is not visible, together with the electric motor and the gearbox, forms a unit 13 for expanding the woven fabric 3 forming the closure 4 of the light emission and/or air outlet opening 2.

If a sponge-like closure (not shown) is disposed in or on the light emission and/or air outlet opening 2, it is not only possible to expand but also compress the closure by pressing it together. Sponge-like shall be understood to mean an open-cell, elastic foam that is air-permeable, the air permeability of which changes as a result of expansion and/or compression. If the sponge-like closure is thin and made of transparent material, it is also translucent and changes the translucency thereof as a result of expansion and/or compression.

Another option of controlling brightness is to use a transparent, elastic film as the closure 4, which in this case is only a light emission opening 2, instead of the woven fabric 3, the translucency of which increases when the film is expanded (not shown). For air permeability, the film or another expandable element can include openings that change the shape and surface area thereof when the film is being expanded. The openings can be short slots transversely to a direction of expansion, for example, which open when the film is expanded. If only the passage of air is desired, the film may be opaque.

The housing 1, together with the woven fabric 3 forming the closure 4 in, on, or at, the light emission and/or air outlet opening 2 forms a light source, or the woven fabric 3 forms an illuminated surface area and/or an air vent for illuminating a passenger compartment and/or venting a passenger compartment of a vehicle, which is not shown. The light source, the illuminated surface area and/or the air vent can also be used to illuminate and/or vent and/or ventilate other spaces.

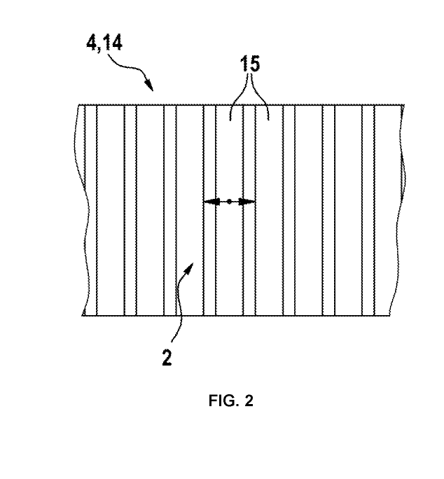

Another option of controlling the air volume and/or for controlling the translucency or brightness is shown in FIG. 2, which shows a light emission and/or air outlet opening 2 according to the invention. There, a blind 14 is provided, having strip-shaped lamellae 15 that can be displaced in the longitudinal direction of the light emission and/or air outlet opening 2 and that are disposed transversely in the light emission and/or air outlet opening 2, having distances between one another that can be varied by displacing the lamellae 15. By varying the distances between the lamellae 15, a volume of light and/or air passing through can be controlled. The displaceability is indicated by a double arrow on one of the lamellae 15.

The lamellae 15 cannot be pivoted and are disposed in a plane of the light emission and/or air outlet opening 2, which is to say transversely to an air flow through the light emission and/or air outlet opening 2.

### LIST OF REFERENCE NUMERALS

1 housing

2 light emission and/or air outlet opening

3 woven fabric

4 closure

5 loop

6 welting

7 shaft

8 pivot mounting

9 rib

10 rear wall

11 fan

12 light source

13 device for expanding the closure 4

14 blind

15 lamella

1. A light emission and/or air outlet opening for a passenger compartment of a vehicle in which a translucent and/or air-permeable closure is disposed, wherein the closure can be expanded and/or compressed, and the translucency and/or air permeability of the closure changes upon expansion or compression of the closure.

2. The light emission and/or air outlet opening according to claim 1, wherein the closure is disposed in the light emission and/or air outlet opening so that no light and/or no air is able to pass by the closure and through the light emission and/or air outlet opening.

3. The light emission and/or air outlet opening according to claim 1, wherein the light emission and/or air outlet opening comprises a device for expanding and/or compressing the closure.

4. The light emission and/or air outlet opening according to claim 1, wherein the closure comprises a firm, elastic, open-cell foam, the pores of which, within the foam, communicate with one another and, on surfaces of the foam, communicate with an environment, so that the foam allows light and/or air to pass through, and a pore size changes upon expansion and/or compression of the foam so that the translucency and/or air permeability of the foam changes.

5. The light emission and/or air outlet opening according to claim 1, wherein the closure comprises a planar or three-dimensional textile, the translucency and/or air permeability of which changes upon expansion or compression.

6. The light emission opening according to claim 1, wherein the closure is transparent and the transparency changes when the closure is being expanded or compressed.

7. The light emission and/or air outlet opening according to claim 1, wherein the closure includes openings extending through from an inflow side to an outflow side, having cross-sectional surface areas that change when the closure is being expanded and/or compressed.

8. The light emission and/or air outlet opening according to claim 7, wherein the closure includes slots, serving as openings, which open and/or widen when the closure is being expanded or compressed.

9. The light emission and/or air outlet opening according to claim 1, wherein the closure comprises a blind including displaceable lamellae, the distance between which is variable by displacement of the lamellae.
